(19) United States
(12) Patent Application Publication
(10) Pub. No.: US 2001/0026133 A1
(43) Pub. Date: Oct. 4, 2001

(54) Regeneration of flat display screen anodes

(76) Inventors: Axel Jager, Meylan (FR); Didier Colas, Perols (FR); Jean-Francois Peyre, Rousset (FR)

Correspondence Address: Arthur L. Plevy, Esq., BUCHANAN INGERSOLL, P.C., 4th Floor, 650 College Road East, Princeton, NJ, 08540, US

(21) Appl. No.: 09/768,971

(22) Filed: Jan. 24, 2001

(30) Foreign Application Priority Data
Jan. 25, 2000 (FR) 00/00932

(51) Int. Cl. G09G 3/10

(52) U.S. Cl. 315/169.3

(57) ABSTRACT

A method for regenerating a cathodoluminescent screen provided with at least one anode adapted to being excited by electron bombarding in a line scanning, consisting of providing regeneration phases during which the anode is at a quiescent potential, a portion only of the lines being addressable in a line scanning upon each regeneration phase, and cathodes being biased in a state corresponding to that of a preceding image.

### BACKGROUND OF THE INVENTION

1. Field of the Invention

The present invention relates to a flat display screen including an anode provided with phosphor elements likely to be excited, for example, by electron bombarding. This electron bombarding requires the biasing of phosphor elements and may originate from microtips, from low extraction potential layers, or from a thermo-ionic source.

2. Discussion of the Related Art

To simplify the present description, only color microtip screens will be considered hereafter, but it should be noted that the present invention generally relates to the various above-mentioned types of screen and the like.

FIG. 1 very schematically shows the functional structure of a flat color microtip screen of the type to which the present invention relates.

Such a screen is essentially comprised of a cathode 1 with microtips 2 and of a grid 3 provided with holes 4 corresponding to the locations of microtips 2. Cathode 1 is placed opposite to a cathodoluminescent anode 5. The cathode associated with the grid is supported by a first plate (not shown), for example, made of glass. The anode is supported by a second glass plate or substrate (not shown). According to whether the screen can be observed from the anode or from the cathode, at least the anode or cathode plate is transparent. In the case of a screen with a transparent cathode, the anode is provided with a surface which is reflective towards the cathode.

The operating principle and the detail of the structure of an example of a microtip screen are described in U.S. Pat. No. 4,940,916 of the Commissariat à l'Energie Atomique.

Cathode 1 is organized in columns and is formed of cathode conductors that can be addressed independently from one another. Grid 3 is organized in rows and an insulating layer (not shown) is interposed between the cathode conductors and the grid. The intersection of a grid row and of a cathode column defines a pixel.

Such a device uses the electric field created between the cathode and the grid to extract electrons from microchips 2 towards phosphor elements 6 of anode 5. For a color screen, anode 5 is, for example, provided with alternate strips of phosphor elements 6R, 6G, 6B, each corresponding to a color (blue, red, green). The strips are separated from one another by an insulator (not shown). Phosphor elements 6R, 6G, 6B are deposited on electrodes 9R, 9G, 9B, formed by corresponding strips of a conductive layer, for example transparent, such as indium and tin oxide (ITO). The sets of blue, red, and green strips are alternately biased with respect to cathode 1, so that the electrons extracted from microtips 2 of a pixel of the cathode/grid are alternately directed to phosphor elements 6 of each color. It is then considered that the screen has several individually-addressable anodes.

A disadvantage of conventional color screens is that, upon biasing of a set of strips of a given color, there is a parasitic emission of the two other colors. Thus, if the lighting order of a given pixel corresponds, for example, to pure or saturated red, a parasitic emission of blue or green can be observed on screen.

This phenomenon is illustrated in FIG. 1 that schematically shows a screen pixel in cross-section along a row of grid 3. On this drawing, a few microtips 2 only have been shown for clarity while they are, in practice, more than one thousand per screen pixel.

It is assumed that conductive strips 9R supporting red phosphor elements 6R are addressed by being biased to a positive potential of several hundreds of volts with respect to cathode 1, while conductive strips 9G and 9B, respectively supporting the green and blue phosphor elements 6G and 6B, are at a zero potential with respect to the cathode. Upon electronic emission by microtips 2 of a given pixel, some parasitic electrons are collected, by the green or blue phosphor elements of this pixel, or even of neighboring pixels in the direction of the rows of grid 3. This parasitic bombarding is due to a residual charge of the green and blue phosphor elements even though the conductive strips 9G and 9B are at a zero potential. Indeed, stray capacitances are present between the phosphor elements and the conductive strip supporting them. Thereby, even when the conductive strip is brought down to ground, phosphor elements remain biased to a potential greater than the minimum microtip biasing potential (for example, 0 volt). The parasitic bombarding phenomenon can be increased by ballistic effect, which results in that some electrons emitted by the microtips facing the green or blue strips do not have enough time to be deviated to be collected by the red phosphor elements. In FIG. 1, the electron path has been symbolically represented by arrows, the path of the parasitic electrons being symbolized by dotted lines.

To solve this problem of parasitic emission, a “regeneration” of the anode is conventionally provided between two display frames. Such a conventional regeneration is illustrated hereafter in relation with FIGS. 2 and 3. These drawings illustrate, in the form of timing diagrams, a conventional example of flat display screen control. In this example several images per second are formed, for example from 50 to 60 images per second, that is, a duration of approximately 20 ms is available to form each image frame. This duration is called frame duration T (FIG. 2).

As shown in FIG. 2, during this frame duration T, three images each corresponding to a color are sequentially formed. In other words, the R. G and B strips are sequentially brought during color sub-frame durations Tr, Tg and Th, to high potentials to be selectively active. Between each frame duration T, a regeneration time or slack time Td corresponding to a regeneration phase is provided. During this time Td, none of the three sets of anode strips is biased. However, the cathode-grid sets are biased to generate an electron emission.

As illustrated in FIG. 3, during each of the color subframes, lines L1, . . . , Li−1, Li, Li+1, . . . , Ln are sequentially brought to a high potential so that all the pixels of the corresponding line are likely to be excited at a given time. While a line is biased, the column conductors of the cathodes are placed at potentials adapted to providing the corresponding pixel with the desired light intensity. In another embodiment, the luminescence level is set by pulse width modulation during each line excitation time.

In duration Td, a grid line scanning is performed as for a normal display. However, to accelerate this regeneration phase, the grid lines are biased successively and in partial superposition since it is generally not possible to simultaneously supply all the lines at the high potential and all the cathodes at the low potential (the supply power would be insufficient). During this phase, the anode strips are at rest, for example at a zero potential.

Such a regeneration process is described, for example, in U.S. Pat. No. 5,872,551.

Similar problems are posed in the case of monochrome screens having an anode formed of two separately biased alternate sets of phosphor elements of same color (it may also be spoken of two anodes). In this case, the addressing is close to that of a color screen with three alternate sets of phosphor elements (it may also be spoken of three anodes).

Problems of parasitic lighting are also encountered in the case of monochrome screens having an anode formed of a plane of phosphor elements of same color. In this case, the image is still formed during a frame time, but without sub-frames. The regeneration is here performed between two frames.

### SUMMARY OF THE INVENTION

The present invention aims at improving the regeneration of a flat display screen anode by exciting the microtips without biasing the anode. In particular, the present invention aims at overcoming a problem of premature screen aging that the inventors assume to be due to the regeneration.

The inventors assume that only the phosphor elements corresponding to the pixels that have been lit during an image display need regeneration, that is, require an evacuation of the residual charges that they can contain. They consider that the premature screen aging is due to the untimely regeneration of screen regions that are not activated during the display of an image. On this regard, they consider that, when regions that have not been charged on the anode side or on the cathode side are regenerated, a local pollution is caused by desorbing species from the accessible layers of the anode and of the cathode-grid. On the cathode-grid side, electrons falling back thereon will have species desorb, causing an accelerated aging of the cathode-grid pixels and of the phosphor elements of the anode.

Based on this acknowledgement, the present invention provides reproducing, during anode regeneration periods, the addressing of the image just displayed, and thus performing a regeneration of the screen anode or anodes by a selective excitation of the microtips with no anode biasing.

A first condition to then be respected is to memorize the displayed images (in fact, the luminance orders, if necessary for each color) during the different sub-frames, to be able to readdress the screen and, in particular, the cathode-grid in the same way during the regeneration sub-frame. This constraint can be relatively easily complied with by associating to the screen means for temporily storing the displayed images. The size of such a memory is acceptable since its storage duration is short and it can be erased by the storage of the next images.

Another difficulty originates from the duration required to reproduce the displayed image during the regeneration period. Indeed, it is in principle necessary to then have, for the regeneration, a duration equivalent to the display duration of an image. In practice, this condition cannot be respected since it would adversely affect the display of the actual images.

The present invention aims at providing a novel regeneration solution that solves these problems and that enables selective regeneration of the screen regions to respect as much as possible the implementation of a regeneration on the areas used for the display.

The present invention also aims at being compatible with an acceptable size of the memory necessary to temporarily store the displayed images for regeneration.

The present invention aims, in particular, at providing a solution that respects the duration generally dedicated to the regeneration phase in a conventional display frame.

To achieve these objects, the present invention provides a method for regenerating a cathodoluminescent screen provided with at least one anode adapted to being excited by electron bombarding in a line scanning, consisting of providing regeneration phases during which the anode is at a quiescent potential, a portion only of the lines being addressable in a line scanning upon each regeneration phase, and cathodes being biased in a state corresponding to that of a preceding image.

The foregoing objects, features and advantages of the present invention will be discussed in detail in the following non-limiting description of specific embodiments, in conjunction with the accompanying drawings.

### BRIEF DESCRIPTION OF THE DRAWINGS

FIGS. 1 to 3, previously described, are meant to show the state of the art and the problem to solve;

FIG. 4 is a simplified example of an image generated by a screen before regeneration;

FIG. 5 very schematically illustrates the regeneration of a screen according to the present invention; and

FIG. 6 illustrates, in the form of timing diagrams, an embodiment of a regeneration according to the present invention.

### DETAILED DESCRIPTION

The same elements have been referred to with the same references in the different drawings. For clarity, only those elements necessary to the understanding of the present invention have been shown in the drawings and will be described hereafter. Similarly, only those steps of an addressing process that are necessary to the understanding of the present invention will be described hereafter.

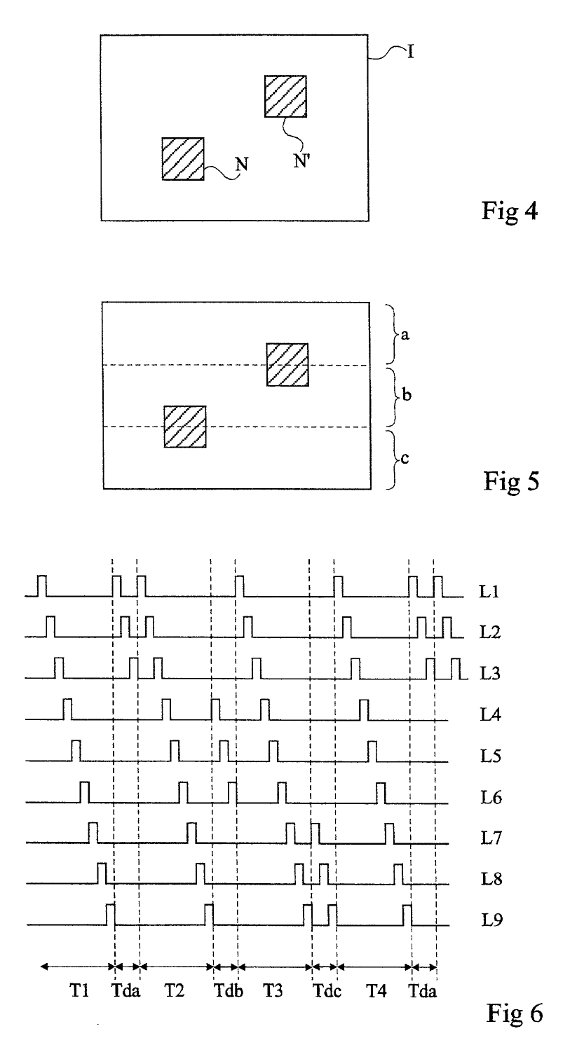

FIG. 4 very schematically shows an example of an image I displayed on a flat display screen of the type to which the present invention applies. In this image, only two areas N and N′ have a non-zero brightness. Accordingly, in the rest of image I, the phosphor elements of the anode receive no electrons. The display of an image I such as illustrated in FIG. 4 is performed conventionally during an image frame (T, FIG. 2). For a color screen, this display is performed, for a complete image, during three color sub-frames.

FIG. 5 illustrates the regeneration which will be performed according to an embodiment of the present invention.

The image I displayed during a frame is memorized to enable a subsequent readdressing of the cathode columns with the luminescence orders corresponding to this image for each color.

During the screen regeneration phase, to make this column addressing compatible with the restricted duration of a regeneration phase, the image (or the screen) is divided into line groups a, b, c. According to the present invention, this screen division during the regeneration is used to regenerate only one group of lines between two images. Thus, according to the present invention, the regeneration of the entire screen is not performed between each image but requires several images to be completed for the entire screen.

The subdivision performed for the regeneration, that is, the number of screen line groups, depends on the available duration for the regeneration phase and on the durations necessary for the column addressing and for scanning the lines of a group during this regeneration phase.

In FIGS. 5 and 6, for the sake of simplicity, a screen of 9 lines divided into three groups of three lines has been considered.

The regeneration performed according to the present invention is illustrated by FIG. 6 which shows, in the form of timing diagrams, the line scanning performed during display frames and regeneration frames.

For simplification, it has been assumed that each line L1, L2, L3, L4, L5, L6, L7, L8, L9 is addressed only once per image frame T1, T2, T3, T4, which corresponds to the case of a monochrome screen, the anode of which includes a single plane of phosphor elements. It should however be noted that the present invention also applies to a color screen (or to a monochrome screen provided with at least two alternate sets of phosphor elements of same color). Then, each line is in practice addressed three times per color frame, that is, once per sub-frame of each color. The embodiment illustrated in FIG. 6 could however correspond, for a color screen, to an alternative embodiment of the present invention which would consist of performing a regeneration period Td between each color sub-frame.

As illustrated in FIG. 6, between two display frames, a regeneration phase Tda, Tdb, Tdc is provided, which only involves one group of lines a, b or c. Each group here includes three lines so that each line is addressed for regeneration once out of three times.

A consequence of this is that the phosphor elements are only discharged one regeneration phase out of three and not upon each phase as in a conventional method. This spacing apart of the regenerations of each area of phosphor elements of the screen is however not disturbing since the regeneration is now performed advisedly, that is, on the areas addressed during the image display.

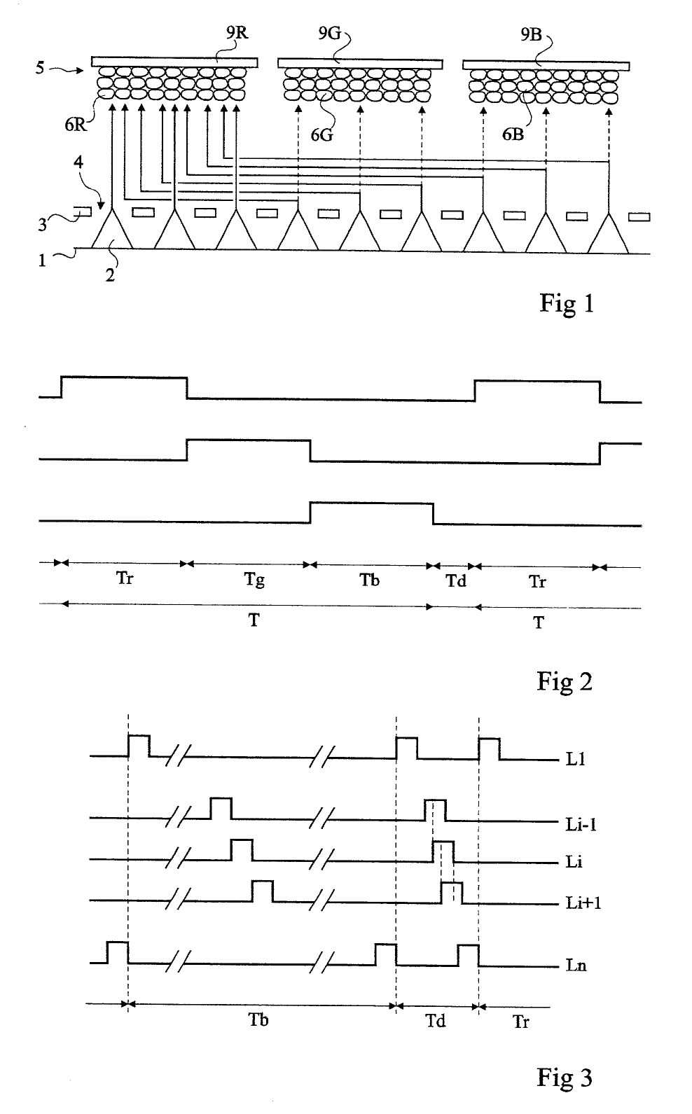

Preferably, during regeneration phases, all the anodes (all the sets of strips 9R, 9G, 9B, FIG. 1) are at the quiescent potential, for example the ground. It should be noted that this helps optimizing the regeneration aimed at by the present invention by enabling a targeted regeneration with low-power electrons. Indeed, during display phases, only the strips of phosphor elements that are addressed accumulate a positive charge that they do not discharge. Accordingly, in a regeneration phase, the electrons emitted by the cathode are attracted by this strip (this anode) which, if it is the only one to have taken part in the display, is at a more positive potential than the strips of the other colors neighboring it. The other strips, if they do not have a positive charge, do not receive (or slightly as compared to the positively-charged strip) regeneration electrons. A preferential regeneration effect towards the strips addressed in display periods is thus obtained.

An advantage of the present invention is that it enables optimizing regeneration phases while avoiding a premature screen aging.

Another advantage of the present invention that it requires no modification of the display itself. Indeed, the present invention is implemented in the conventional durations assigned to regeneration phases. Thus, the implementation of the present invention is compatible with conventional display constraints.

The frequency of the regeneration phases may be adapted according to screens and to applications. In particular, the regeneration phases may be spaced apart, that is, reproduced at a frequency different from that of the images, or brought closer together, that is, reproduced at the color sub-frame frequency. In each case, this modification will result in a modification of the frequency of line regeneration according to the present invention, without it being necessarily required to modify their group distribution.

As a specific example of implementation, for a screen with 240 lines, 24 groups of 10 lines which will thus be regenerated once every 24 images may be provided. Indeed, it can be considered that, statistically, the images scarcely move within one second so that, even with a frequency of 20 to 25 images per second which approximately corresponds to the eye perception threshold, such a subdivision is perfectly realistic.

Thus, according to the present invention, it is not necessary to store all images, but only one image out of n, where n is the number of screen subdivision groups. Accordingly, the memory size required to store the column addressing data to restore them in regeneration periods corresponds to the display size of a single image. Thus, an advantage of the present invention is that it minimizes the memory required for the storage of the data necessary to the regeneration.

Of course, the present invention is likely to have various alterations, modifications, and improvements which will readily occur to those skilled in the art. In particular, the choice of the number of lines per regeneration group and of the frequency of the regeneration phases depends on the screen and on the application. Further, the implementation of the present invention by modification of the display programs is within the abilities of those skilled in the art based on the functional indications given hereabove, using the means conventionally used for screen addressing. Further, it should be noted that although the present invention has been described hereabove in relation with line groups formed of successive lines, each line group may includes non-successive lines, provided that their respective addressings are modified accordingly. Further, it should be noted that although the luminance order is brought by the grid rows and not by the cathode columns, which amounts to performing a column scanning, the present invention may easily be transposed.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for regenerating a cathodoluminescent screen provided with at least one anode (9R, 9G, 9B) adapted to being excited by electron bombarding in a line scanning, consisting of providing regeneration phases (Td) during which the anode is at a quiescent potential, wherein a portion only of the lines is addressed in a line scanning (3) upon each regeneration phase (Tda, Tdb, Tdc), cathodes (1) being biased in a state corresponding to that of a preceding image.

2. The method of claim 1, consisting of memorizing the addressing orders of the cathodes (1) for the display of an image, with a frequency corresponding to the regeneration frequency of each line (3).

3. The method of claim 1, wherein the regeneration phases (Tda, Tdb, Tdc) are interposed between display phases.

4. The method of claim 1, applied to a screen provided with at least two anodes (9R, 9G, 9B), wherein a portion at least of the anodes is at the quiescent potential during regeneration phases.

5. The method of claim 4, wherein the display phases correspond to sub-frames respectively assigned to the anodes, one regeneration phase (Tda, Tdb, Tdc) being interposed between each sub-frame (Tr, Tg, Tb).

6. The method of claim 4, wherein the display phases correspond to display frames grouping sub-frames respectively assigned to the anodes, one regeneration phase (Tda, Tdb, Tdc) being interposed between each display frame (T1, T2, T3).

7. The method of claim 4, wherein all anodes (9R, 9G, 9B) are, during regeneration phases, at the quiescent potential.

8. The method of claim 1, wherein the screen is a color microtip screen (2).

9. The method of claim 1, wherein the screen is a monochrome microtip screen (2).
